(19) United States
(12) Patent Application Publication
(10) Pub. No.: US 2022/0380928 A1
(43) Pub. Date: Dec. 1, 2022

(54) METHOD AND SYSTEM OF POWDER COATING A VEHICLE COMPONENT

(71) Applicant: Nissan North America, Inc., Franklin, TN (US)

(72) Inventors: Nanzhu ZHAO, Novi, MI (US); Sandeep PATIL, Farmington Hills, MI (US)

(21) Appl. No.: 17/334,736

(22) Filed: May 29, 2021

(51) Int. Cl. C25D 15/02; C25D 21/02

(52) U.S. Cl. CPC C25D 15/02; C25D 21/02

(57) ABSTRACT

A method of painting a vehicle component includes charging the vehicle component. The charge of the vehicle component in an area to be painted is selectively changed. Paint is applied to the vehicle component. The vehicle component is heated to fuse the paint to the vehicle component.

### BACKGROUND

### Field of the Invention

The present invention generally relates to a method and system of painting a vehicle component. More specifically, the present invention relates to a method and system of selectively charging an area of a vehicle component to be painted to attract oppositely charged paint.

### Background Information

Automotive painting conventionally uses a liquid paint in a process that includes applying the liquid paint by spraying. After the applied liquid paint dries, the painted component is then baked to cure the applied liquid paint. The liquid paint process introduces many challenges, such as sagging, peeling, fading and mismatching of the applied liquid paint. Multi-color painting further requires masking to prevent paint from being applied in an undesired area. These problems are associated with the fluid properties of the liquid paint, such as the density, viscosity, surface tension, and surface energy of the liquid paint.

### SUMMARY

A need exists for a method and system of painting a vehicle component.

In view of the state of the known technology, one aspect of the present disclosure is to provide a method of painting a vehicle component. The vehicle component is charged. The charge of the vehicle component in an area to be painted is selectively changed. Paint is applied to the vehicle component. The vehicle component is heated to fuse the paint to the vehicle component.

Another aspect of the present invention is to provide a powder coating system for painting a vehicle component. An immersion bath forms a charge generation layer on the vehicle component. An electrostatic generator charges the vehicle component. A first laser selectively changes the charge of the vehicle component in an area to be painted. A paint applicator applies paint to the vehicle component. A second laser heats the vehicle component to fuse the paint to the vehicle component.

Also other objects, features, aspects and advantages of the disclosed method and system of powder coating a vehicle component will become apparent to those skilled in the art from the following detailed description, which, taken in conjunction with the annexed drawings, discloses exemplary embodiments of the method and system of powder coating a vehicle component.

### BRIEF DESCRIPTION OF THE DRAWINGS

Referring now to the attached drawings which form a part of this original disclosure:

FIG. 1 is a flowchart illustrating a process of painting a vehicle component in accordance with an exemplary embodiment of the present invention;

FIG. 2 is an illustration of a vehicle component passing through an immersion bath;

FIG. 3 is an illustration of the vehicle component of FIG. 2 being charged after the immersion bath;

FIG. 4 is an illustration of the vehicle component of FIG. 3 being selectively charged;

FIG. 5 is an illustration of a laser system for selectively charging a vehicle component;

FIG. 6 is an illustration of the components of the laser of the laser system of FIG. 5;

FIG. 7 is an illustration of the vehicle component of FIG. 4 in which a trunk is selectively charged;

FIG. 8 is an illustration of paint being applied to the vehicle component of FIG. 8 by spraying;

FIG. 9 is an illustration of the vehicle component of FIG. 4 in which a front driver door is selectively charged;

FIG. 10 is an illustration of a roller system for applying paint to a vehicle component;

FIG. 11 is an illustration of using a laser system to fuse paint applied to the vehicle component;

FIG. 12 is an illustration of the vehicle component of FIG. 7 after fusing paint applied to the trunk; and

FIG. 13 is an illustration of the vehicle component of FIG. 9 after fusing paint applied to the front driver door.

### DETAILED DESCRIPTION OF EXEMPLARY EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

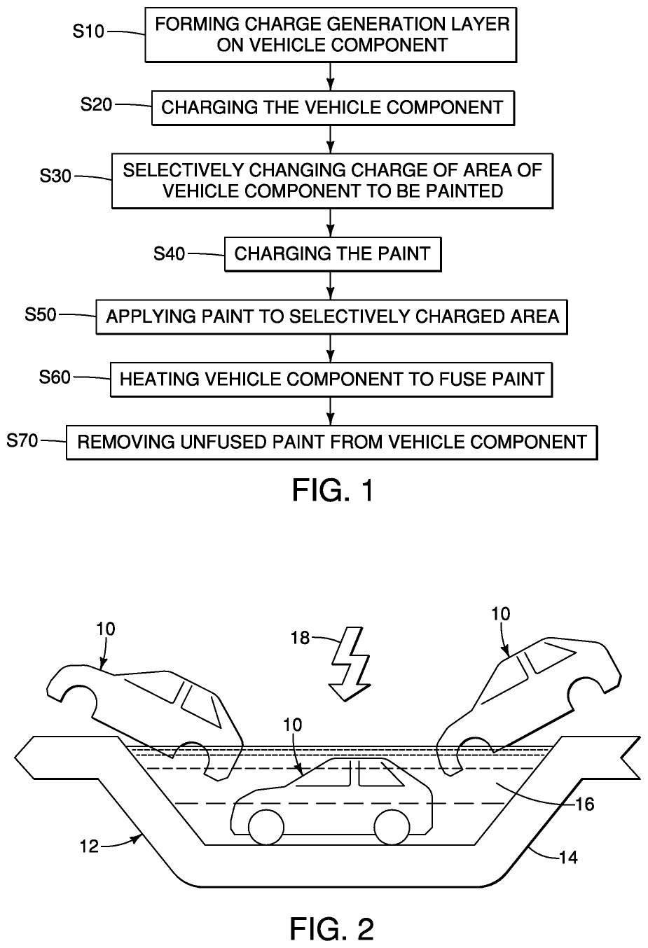

Referring initially to FIG. 1, a flowchart illustrates a process of painting a vehicle component in accordance with an exemplary embodiment of the present invention.

In Step S10 of the flowchart of FIG. 1, a vehicle component 10 is immersed in a conventional immersion bath 12, as shown in FIG. 2. The vehicle component 10 can be any vehicle component requiring paint, such as a vehicle body, an engine, a power module, or portions thereof. The immersion bath 12 includes a tank 14 containing an electrodeposition solution 16. The electrodeposition solution 16 preferably includes approximately 80-90% water and 10-20% paint solids. The paint solids preferably include a resin, a binder, and a pigment. The paint solids are preferably under constant agitation while the vehicle component 10 is immersed in the immersion bath 12. The resin provides corrosion resistance and durability. The pigment provides color and gloss. An electric current 18 is passed through the vehicle component 10 and the electrodeposition solution 16 to form an electrodeposition coat, or e-coat or charge generation layer, 20 on a surface 22 of the vehicle component 10, as shown in FIG. 4. The e-coat 20 includes a photoconductive polymer, such as, but not limited to, polyvinylcarbazole (PVK), polysilene, or polyphosphazene. The electric current 18 is applied until a desired thickness of the e-coat 20 is obtained. The vehicle component 10 can be passed through the immersion bath 12 while connected to an overhead conveyor to facilitate completely immersing the vehicle component 10 in the electrodeposition solution 16 in the immersion bath 12. The immersion bath 12 provides a substantially uniform e-coat 20 on the vehicle component 10.

The vehicle component 10 is then passed to a conventional oven in which heat is applied to the vehicle component 10. The heating cures the e-coat 20, which facilitates adhesion of the e-coat 20 to the vehicle component 10. The heating can be at any suitable temperature for any suitable amount of time, such as at approximately 160 degrees Celsius for approximately ten minutes.

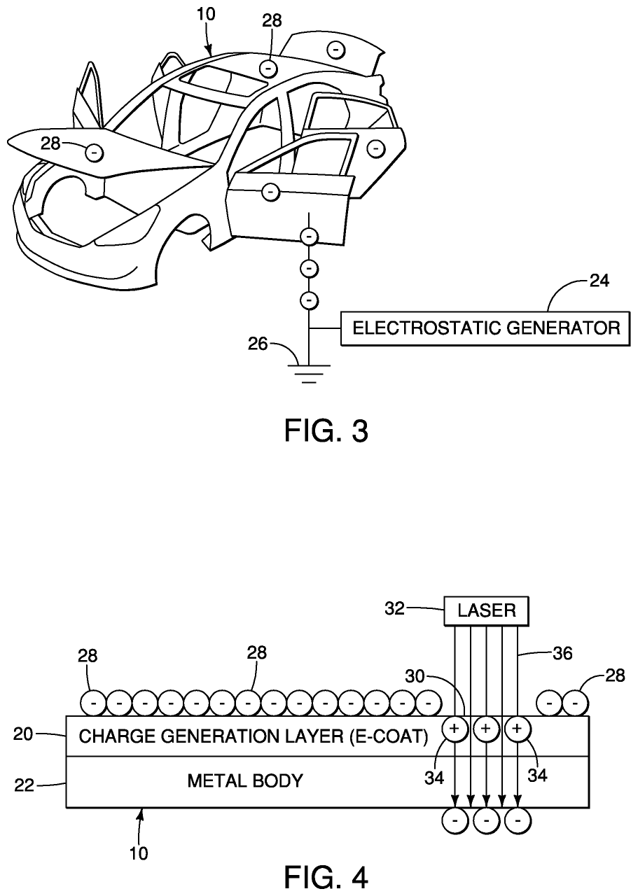

The process then moves to step S20 of the flowchart of FIG. 1 in which the vehicle component 10 is charged. As shown in FIG. 3, the vehicle component 10 is connected to an electrostatic generator 24 and to ground 26. The vehicle component 10 is connected to a negative terminal of the electrostatic generator 24 such that the vehicle component 10 is negatively charged. In other words, the entirety of the vehicle component 10 has a negative charge 28, as shown in FIGS. 3 and 4. Alternatively, the vehicle component 10 can be positively charged in step S20, and the charges described hereafter would be opposite as described.

The process then moves to step S30 of the flowchart of FIG. 1 in which the charge of an area 30 of the vehicle component 10 to be painted is selectively changed. The vehicle component 10 is preferably disconnected from the electrostatic generator 24 or the electrostatic generator 24 is turned off such that any area in which the charge is selectively changed is not returned to the original charge by the electrostatic generator 24. As shown in FIG. 4, a first laser 32 treats the surface of the area 30 to be painted to selectively change the charge from the negative charge 28 to a positive charge 34. When a laser beam 36 emitted by the first laser 32 hits the area 30 of the vehicle component 10, the area 30 becomes electrically conductive because of the photoconductive properties of the e-coat 20. The photoconductive polymer is a material that becomes more electrically conductive when hit by a photon, such as visible light, ultraviolet light, infrared light, or gamma radiation. The electrons of the laser beam 36 pass freely through the e-coat 20, such that the area 30 cannot hold the negative charge 28 and becomes positively charged. In other words, the first laser 32 erases the negative charge 28 in the area 30 of the vehicle component 10 hit by the laser beam 36 and provides the area 30 with a positive charge 34.

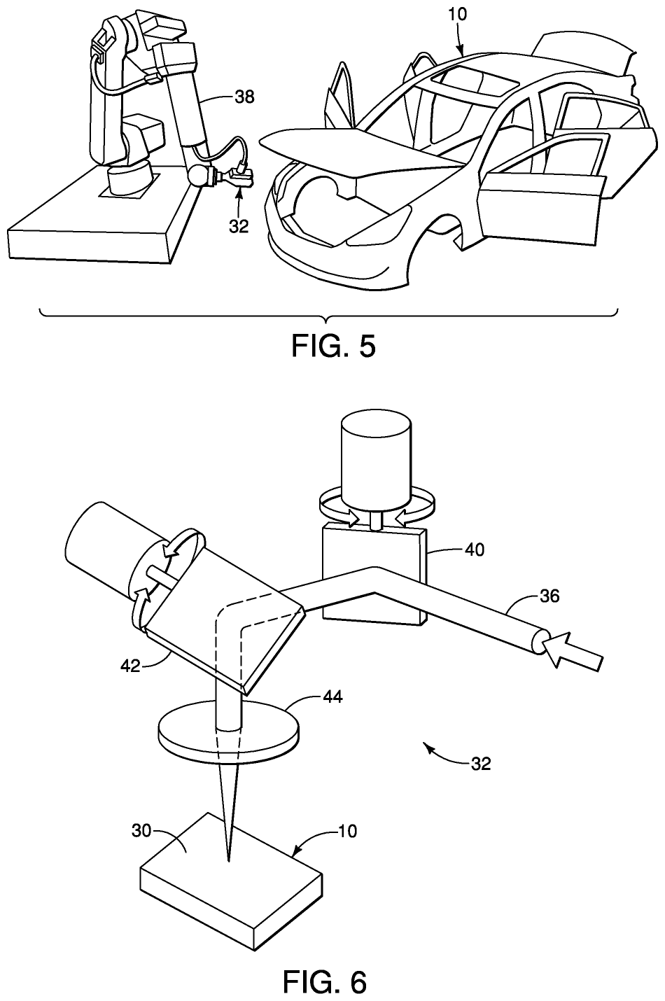

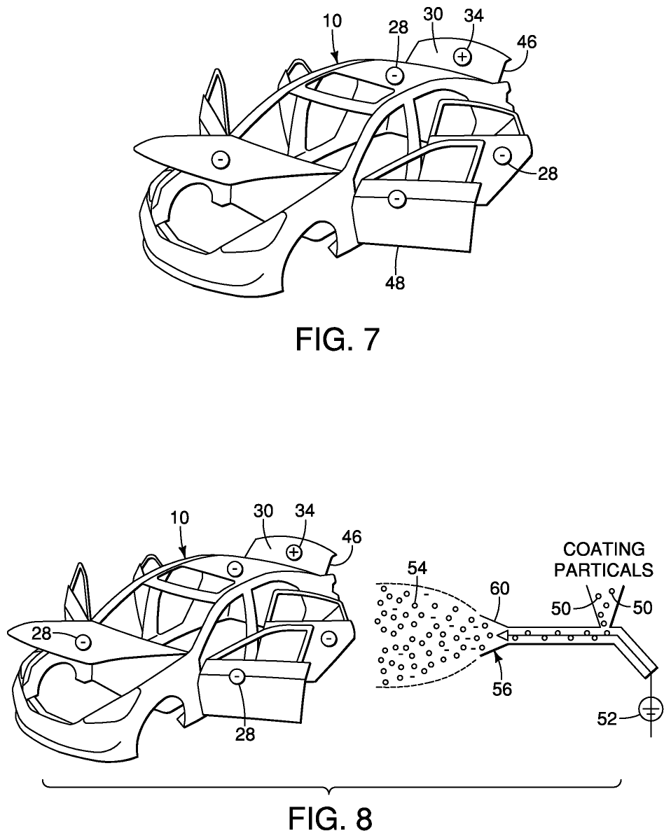

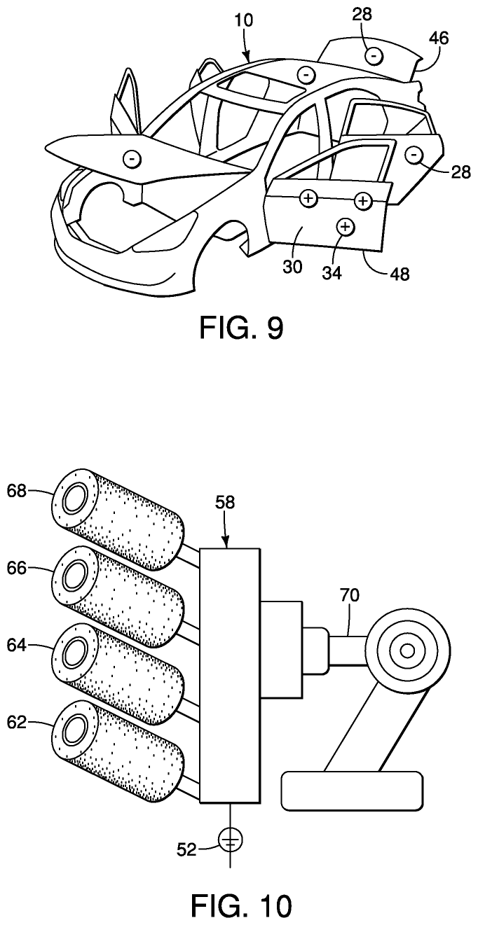

An exemplary embodiment of the first laser 32 is shown in FIGS. 5 and 6. The first laser 32 can be connected to a robotic arm 38 to accurately control the application of the laser beam 36 emitted by the first laser 32 on the vehicle component 10. The first laser 32 can include first and second turning mirrors 40 and 42 to aim the laser beam 36. The first turning mirror 40 can control the direction of the laser beam 36 in the X-axis direction and the second turning mirror 42 can control the direction of the laser beam 36 in the Y-axis direction. The laser beam 36 then passes through a focusing lens 44 to concentrate the energy of the laser beam into a smaller area. The robotic arm 38 precisely controls the first laser 32 such that the charge is selectively changed in only the area 30 of the vehicle component 10 to be painted. The area 30 to be painted can be any size, such as the entire vehicle body, or a portion of a vehicle component 10, such as the trunk 46 (FIG. 7) or the front driver door 48 (FIG. 9). Alternatively, the area 30 to be painted can be a specific design, shape or pattern on the vehicle component 10.

The process then moves to step S40 of the flowchart of FIG. 1 in which paint 50 to be applied to the vehicle component 10 is charged, as shown in FIG. 8. A high-voltage generator 52, or other suitable device for imparting a charge to the paint 50, charges the paint 50 prior to the paint being applied to the vehicle component 10. As shown in FIG. 8, the paint 50 is provided with a negative charge such that the negatively charged paint 54 is attracted to the positive charge 34 of the area 30 to be painted.

The process then moves to step S50 of the flowchart of FIG. 1 in which the charged paint 54 is applied to the selectively charged area 30 of the vehicle component 10 with a paint applicator, as shown in FIG. 8. The charged paint 54 can be applied in any suitable manner, such as being sprayed with a sprayer assembly 56 (FIG. 8) or rolled with a roller assembly 58 (FIG. 10). As shown in FIG. 8, the positive charge 34 of the area 30 to be painted attracts the negatively charged paint 54 such that the negatively charged paint 54 bonds to the positively charged area 30 to be painted. The negative charge 28 of the remaining area of the vehicle component 10 that is not being painted repels the similarly charged paint 54. In other words, the area 30 to be painted (positively charged) attracts the oppositely charged paint 54 (negatively charged), and the remaining area (negatively charged) repels the similarly charged paint 54 (negatively charged). The sprayer assembly 56 can include a plurality of sprayers 60, such that different colored paints are separately applied. For example, the sprayer assembly 56 can include four sprayers in which a first sprayer includes black paint, a second sprayer includes cyan paint, a third sprayer include magenta paint, and a fourth sprayer includes yellow paint. Each of the paints of the four sprayers is charged prior to being applied to the vehicle component 10. The plurality of sprayers 60 allows a multi-color image or pattern to be painted on the vehicle component 10.

As shown in FIG. 10, the roller assembly 58 can be used to apply the paint. The roller assembly 58 includes four rollers. A first roller 62 applies black paint. A second roller 64 applies cyan paint. A third roller 66 applies magenta paint. A fourth roller 68 applies yellow paint. The rollers 62, 64, 66 and 68 of the roller assembly 58 can be connected to a robotic arm 70 to precisely apply the paint. Similarly to the sprayer assembly 56 illustrated in FIG. 8, the roller assembly 58 is connected to a high-voltage generator to charge the paint of each roller 62, 64, 66 and 68 prior to being applied to the vehicle component 10.

The paint 50 is preferably a dry powder paint suitable for powder coating, such as an epoxy or polyester with metal pigments.

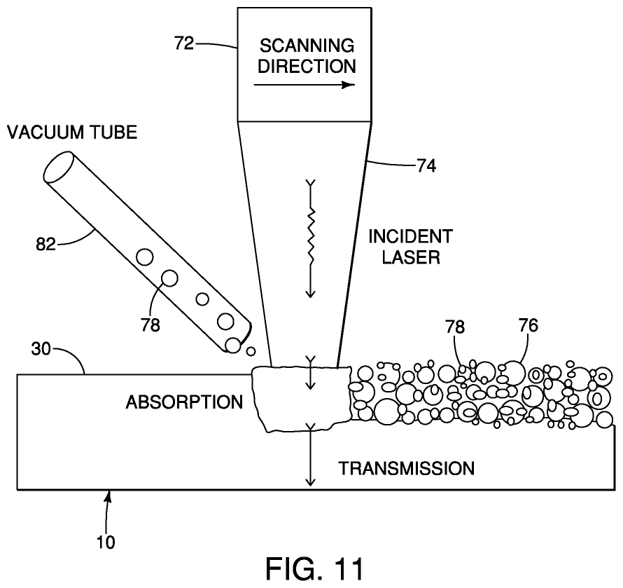

The process then moves to step S60 of the flowchart of FIG. 1 in which the vehicle component 10 is heated to fuse or anneal the applied paint, as shown in FIG. 11. A second laser 72 applies a laser beam 74 to the painted area 30. The heat of the applied laser beam 72 fuses the paint 76 to the vehicle component 10. The fusing of the paint by the second laser 72 preferably eliminates the step of baking the vehicle component in an oven to fuse the paint.

The process then moves to step S70 of the flowchart of FIG. 1 in which unfused paint 78 is removed from the vehicle component 10, as shown in FIG. 11. Suction is applied to the vehicle component 10 to remove unfused paint 78. Suction can be applied in any suitable manner, such as through a tube 80. Alternatively, the unfused paint 78 can be removed by blowing air over the vehicle component 10 through the tube 80. Preferably, the unfused paint 78 is removed after the vehicle component 10 is heated by the second laser 72. Alternatively, the unfused paint 78 can be removed substantially contemporaneously with the heating of the vehicle component 10.

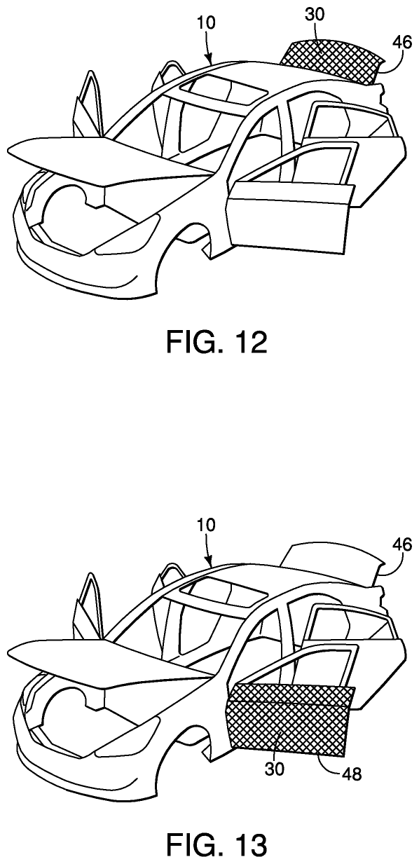

As shown in FIG. 12, the trunk 46 of the vehicle component 10 is painted in accordance with the method and system of painting a vehicle component of the present invention. As shown in FIG. 13, the front driver door 48 of the vehicle component 10 is painted in accordance with the method and system of painting a vehicle component of the present invention. As shown in FIGS. 12 and 13, painting the vehicle component in accordance with the exemplary embodiments of the present invention paints only the area 30 of the vehicle component 10 desired to be painted with the remaining area of the vehicle component 10 not being painted. The method and system of painting a vehicle component in accordance with exemplary embodiments of the present invention provides a painted component that has improved corrosion resistance and improved durability when exposed to high temperatures and ultraviolet light. The method and system of painting a vehicle component in accordance with exemplary embodiments of the present invention preferably uses a dry, powder paint, such that the disadvantages associated with a liquid paint, such as sagging and fading, and the considerations associated with a liquid paint, such as density, viscosity, surface tension and surface energy, are substantially eliminated.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle painted with the method and system of powder coating a vehicle component. Accordingly, these terms, as utilized to describe the present invention should be interpreted relative to a vehicle pained with the method and system of powder coating a vehicle component.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A method of painting a vehicle component comprising:
charging the vehicle component;
selectively changing the charge of the vehicle component in an area to be painted;
applying paint to the vehicle component; and
heating the vehicle component to fuse the paint to the vehicle component.

2. The method according to claim 1, further comprising
removing unfused paint from the vehicle component.

3. The method according to claim 2, wherein
unfused paint is removed by applying suction to the vehicle component.

4. The method according to claim 2, wherein
unfused paint is removed by blowing air over the vehicle component.

5. The method according to claim 2, wherein
the unfused paint is removed after the vehicle component is heated.

6. The method according to claim 2, wherein
the unfused paint is removed substantially contemporaneously with the heating of the vehicle component.

7. The method according to claim 1, wherein
the vehicle component is negatively charged.

8. The method according to claim 7, wherein
the area of the vehicle component to be painted is changed to a positive charge.

9. The method according to claim 8, further comprising
charging the paint prior to applying the paint to the vehicle component.

10. The method according to claim 9, wherein
the paint is negatively charged, the positively charged area of the vehicle component attracting the negatively charged paint.

11. The method according to claim 1, wherein
the paint is a dry powder.

12. The method according to claim 1, wherein
the paint is applied by spraying.

13. The method according to claim 1, wherein
the paint is applied by rolling.

14. The method according to claim 1, further comprising
forming a charge generation layer on the vehicle component prior to charging the vehicle component.

15. The method according to claim 14, wherein
the charge generation layer is formed by immersing the vehicle component in a solution.

16. The method according to claim 1, wherein
the charge of the vehicle component in the area to be painted is selectively changed with a first laser.

17. The method according to claim 16, wherein
the vehicle component is heated with a second laser.

18. A powder coating system for painting a vehicle component, comprising:
an immersion bath for forming a charge generation layer on the vehicle component;
an electrostatic generator for charging the vehicle component;
a first laser for selectively changing the charge of the vehicle component in an area to be painted;
a paint applicator for applying paint to the vehicle component; and
a second laser for heating the vehicle component to fuse the paint to the vehicle component.

19. The powder coating system according to claim 18, wherein
the paint is a powder paint.

20. A powder coating system for painting a vehicle component, wherein
the paint applicator applies the paint by spraying.
